(19) United States
(12) Patent Application Publication
(10) Pub. No.: US 2024/0354829 A1
(43) Pub. Date: Oct. 24, 2024

(54) AUTOMATICALLY GENERATING AND OPERATING AN ITEM TRANSFER MECHANISM THAT IS INTEGRATED INTO AN EXPERT'S ONLINE PRESENCE

(71) Applicant: Artica Inc., Belllevue, WA (US)

(72) Inventors: Steven Hoelscher, Seattle, WA (US); Sebastian Wickenburg, Bothell, WA (US); Marcus Heijer, Seattle, WA (US); Barrett Rodgers, Seattle, WA (US); David Fagnan, Shoreline, WA (US)

(21) Appl. No.: 18/304,205

(22) Filed: Apr. 20, 2023

(51) Int. Cl. G06Q 30/0601

(52) U.S. Cl. CPC G06Q 30/0631

(57) ABSTRACT

A facility for automatically establishing an integrated item transfer mechanism on behalf of an expert is described. The facility accesses an online presence of the expert to extract content from it. The facility identifying items referred to by the extracted content. For each identified item, the facility identifies content among the extracted content that characterizes the identified item. The facility constructs an item transfer mechanism that makes each of the identified items available for transfer to transferees that incorporates, for each of the identified items, content among the extracted content identified as characterizing the identified item. The facility operates the item transfer mechanism in a production mode for transferees.

### BACKGROUND

Experts publish information about items in item categories to which their expertise extends. For example, they may inspect and use items in these categories, and publish media artifacts showing them, discussions describing them, and/or evaluations assessing them. In some cases, the expert performs such publication in the context of an online presence of the expert, such as a social media account of the expert. In some cases, such publication is supported and/or rewarded by one or more separate parties associated with the item, such as the source or provider of the item.

### BRIEF DESCRIPTION OF THE DRAWINGS

FIG. 1 is a network diagram showing a network environment in which the facility operates in some embodiments.

FIG. 2 is a block diagram showing some of the components typically incorporated in at least some of the computer systems and other devices on which the facility operates.

FIG. 3 is a flow diagram showing a process performed by the facility in some embodiments to implement an integrated item transfer mechanism on behalf of an expert.

FIG. 4 is a display diagram showing a preview view of a homepage of a sample item transfer mechanism constructed by the facility in some embodiments.

FIG. 5 is a display diagram showing a sample display presented by the facility in some embodiments to show details about an item listed for transfer on the item transfer mechanism constructed by the facility.

FIG. 6 is a display diagram showing a sample display presented by the facility in some embodiments to edit the item detail page shown in FIG. 5.

FIG. 7 is a display diagram showing sample contents of a display presented by the facility in some embodiments to enable the expert to edit the homepage display shown in FIG. 4.

FIG. 8 is a display diagram showing sample contents of a display presented by the facility in some embodiments to edit the set of items listed for transfer on the item transfer mechanism.

FIG. 9 is a display diagram showing sample contents of a display presented by the facility in some embodiments to show a page for a particular collection of items.

FIG. 10 is a display diagram showing sample contents of a display presented by the facility in some embodiments to edit an item collection.

FIG. 11 is a display diagram showing sample contents of a display presented by the facility in some embodiments to manage item source approvals.

### DETAILED DESCRIPTION

The inventors have recognized that support or rewards for an expert are often predicated on transfers of items caused by the expert. The inventors have further recognized that transfer of the item typically involves the expert inducing a prospective transferee to arrange transfer using a mechanism separate and experientially distinct from the expert's online presence.

The inventors have also recognized that, were an expert able to integrate into their online presence a mechanism for transferring items published about by the expert, prospective transferees would be more likely to arrange transfers of these items via this integrated transfer mechanism than via a separate item transfer mechanism.

The inventors have additionally recognized that constructing such integrated transfer mechanisms is a difficult and specialized undertaking that is beyond the ability of most experts, and is also a project that can be prohibitively expensive to outsource to those better-equipped to perform it.

In response to these recognitions, the inventors have conceived and reduced to practice a software and/or hardware facility for automatically generating and operating an item transfer mechanism that is integrated into an expert's online presence (“the facility”).

In some embodiments, the facility automatically analyzes the expert's online presence to extract a variety of information, including particular items published about by the expert; item categories containing those items; sources of those items; particular content published about those items, including both text, media artifacts, and content of other types; stylistic choices made in designing the online presence and content published there; etc.

The facility uses the extracted information to generate a proposed integrated item transfer mechanism for the expert. In some embodiments, the facility applies a large language model such as GPT-4 and/or natural language models of other types to the extracted information to identify items published about in the online presence, and content artifacts such as text, images, videos, etc., that relate to these. The facility uses the identified items as a basis for choosing items to list for transfer in the proposed integrated item transfer mechanism. For example, in various embodiments, the facility lists for transfer some or all of the identified items; other items whose item categories match or are similar to item categories of identified items; other items whose sources are the same as identified items; or combinations thereof. For each listed item, the facility adds to the proposed integrated item transfer mechanism information from the online presence relevant to the item, such as the expert's photos or videos of it, the expert's text describing it, the expert's ratings of it, etc. In some embodiments, the facility uses language models and/or Al tools of other types-including generative models for image and video artifacts as well as text-to generate new content to include items that is based on and/or in the same voice or perspective as content from the online presence.

The facility also uses the extracted information to establish expert identification and branding details for the proposed integrated item transfer mechanism, including such aspects as expert name, image, biography, and blog. In some embodiments, the facility also adds collections of items to the proposed integrated item transfer mechanism, such as by identifying groups of items discussed together in the online presence, or groups of items judged to be similar by a natural language model applied to then. The facility further uses the extracted information to establish stylistic details for the proposed integrated item transfer mechanism, including details such as text color, font, and/or size; background color or pattern; line weight; etc.

The facility makes a preview of the proposed integrated item transfer mechanism available for review by the expert, in some embodiments both in a form optimized for use in a desktop or laptop browser, and in a form optimized for use on a smartphone, tablet, or other mobile device. During preview, the expert sees the integrated item transfer mechanism as prospective item transferees will see it once live. The expert can choose elements of the proposed integrated item transfer mechanism to alter, such as editing text, substituting or reordering image or video artifacts, changing or reordering items listed for transfer, etc. The facility reflects these alterations in subsequent previews, as well as the live integrated item transfer mechanism once launched.

In some embodiments, inclusion of at least some items in a live integrated item transfer mechanism is subject to the approval of the source of those items, or representatives of the source. For the items listed in the proposed integrated item transfer mechanism, the facility tracks approval status, and assists the expert in procuring source approvals still needed. At any point, the expert can launch the integrated item transfer mechanism with the set of items that are not still waiting for approval.

When the expert chooses to launch the integrated item transfer mechanism, the facility integrates it into the expert's online presence. In various embodiments, this integration is by adding one or more direct or indirect links to the integrated item transfer mechanism to the online presence, and or by causing the integrated item transfer mechanism to be embedded in the online presence. This process makes the integrated item transfer mechanism usable by item transferees—such as via a web browser—from the expert's online presence to request the transfer to them of items listed for transfer in the integrated item transfer mechanism.

By operating in some or all of the ways described above, the facility makes it easy for experts to create and launch an item transfer mechanism that is integrated with their online presence, which in turn makes it easy for item transferees to obtain transfer of items published about by experts.

Additionally, the facility improves the functioning of computer or other hardware, such as by reducing the dynamic display area, processing, storage, and/or data transmission resources needed to perform a certain task, thereby enabling the task to be permitted by less capable, capacious, and/or expensive hardware devices, and/or be performed with lesser latency, and/or preserving more of the conserved resources for use in performing other tasks. For example, by automatically generating an initial version of an integrated item transfer mechanism, the facility obviates the greater use of processor cycles and network capacity that would be needed to manually create an initial version of an integrated item transfer mechanism. By providing high-level controls for editing that initial version of an integrated item transfer mechanism, the facility similarly obviates the greater use of processor cycles and network capacity that would be needed to more manually revise the initial version of an integrated item transfer mechanism.

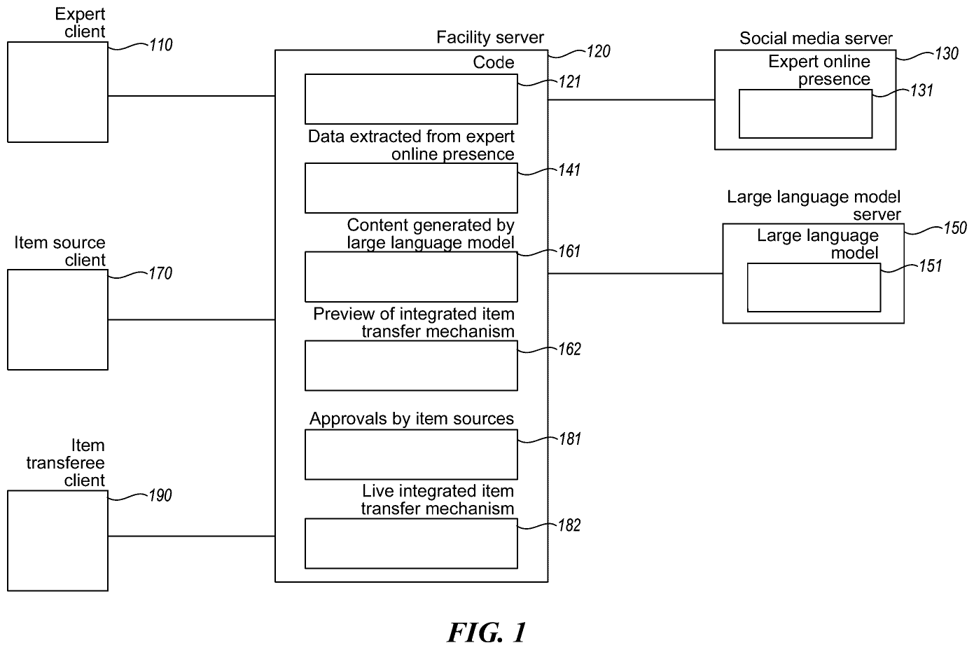

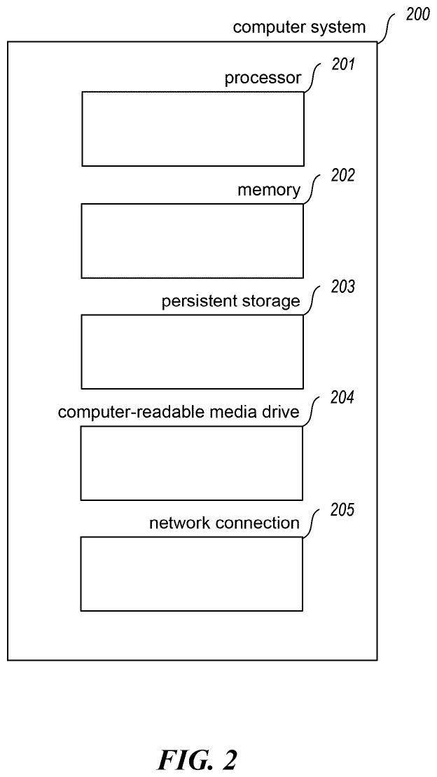

FIG. 1 is a network diagram showing a network environment in which the facility operates in some embodiments. In some embodiments, some or all of the network nodes shown in FIG. 1 have components in accordance with FIG. 2 discussed below. An expert client 110 used by the expert connects to a facility server 120, such as via the Internet, or another public, private, or quasi-private network. The facility server hosts code 121 for the facility that the expert can trigger in order to construct an item transfer mechanism that is integrated with the expert's online presence. In some embodiments, the expert provides authorization and/or login credentials that enable the facility server to connect to a server hosting the expert's online presence 131, such as a social media server.

The facility uses this access to the expert's online presence to extract data 141 from the expert online presence. In various embodiments, the facility performs a variety of forms of analysis and synthesis against the extracted data. In some embodiments, this analysis involves one or more invocations of a large language model 151 resident on a large language model server 150. Such invocations generate content 161 stored by the facility. The facility uses this content, as well as, in some embodiments, some of the original data extracted from the online presence, to construct a tentative or “preview” version of an integrated item transfer mechanism 162 for the expert.

In some embodiments, the facility interacts with sources of the items listed for transfer in the item transfer mechanism via one or more item source clients 170 to seek and obtain approval from those sources for their items to be listed in the item transfer mechanism. In various embodiments, the facility involves the expert in various ways in these interactions. Once approvals have been received for all or an adequate number of the items, the facility launches a live version 182 of the integrated transfer mechanism, for access and use by item transferees using item transferee client 190 to obtain the transfer of items listed for transfer by the integrated item transfer mechanism.

FIG. 2 is a block diagram showing some of the components typically incorporated in at least some of the computer systems and other devices on which the facility operates. In various embodiments, these computer systems and other devices 200 can include server computer systems, cloud computing platforms or virtual machines in other configurations, desktop computer systems, laptop computer systems, netbooks, mobile phones, personal digital assistants, televisions, cameras, automobile computers, electronic media players, etc. In various embodiments, the computer systems and devices include zero or more of each of the following: a processor 201 for executing computer programs and/or training or applying machine learning models, such as a CPU, GPU, TPU, NNP, FPGA, or ASIC; a computer memory 202 for storing programs and data while they are being used, including the facility and associated data, an operating system including a kernel, and device drivers; a persistent storage device 203, such as a hard drive or flash drive for persistently storing programs and data; a computer-readable media drive 204, such as a floppy, CD-ROM, or DVD drive, for reading programs and data stored on a computer-readable medium; and a network connection 205 for connecting the computer system to other computer systems to send and/or receive data, such as via the Internet or another network and its networking hardware, such as switches, routers, repeaters, electrical cables and optical fibers, light emitters and receivers, radio transmitters and receivers, and the like. While computer systems configured as described above are typically used to support the operation of the facility, those skilled in the art will appreciate that the facility may be implemented using devices of various types and configurations, and having various components.

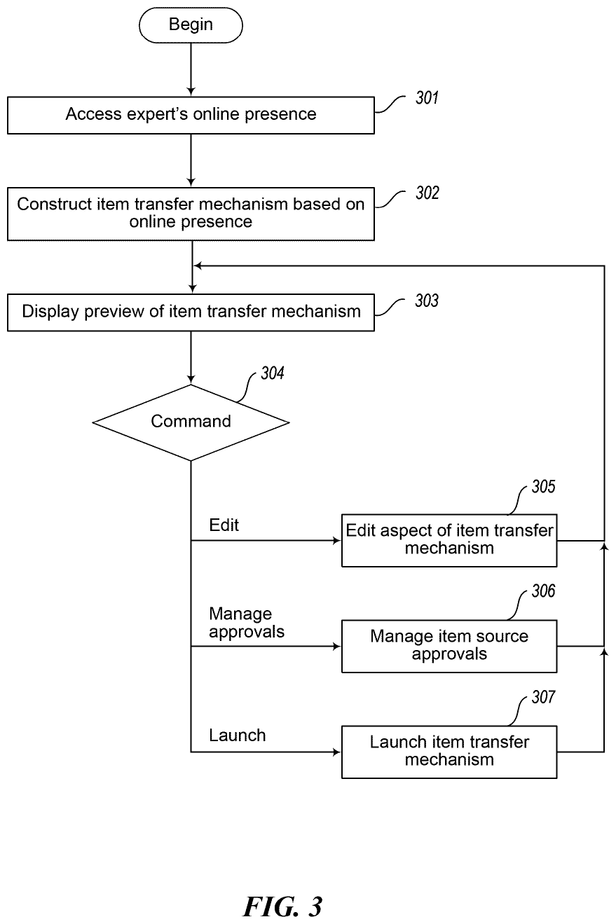

FIG. 3 is a flow diagram showing a process performed by the facility in some embodiments to implement an integrated item transfer mechanism on behalf of an expert. In act 301, the facility accesses the expert's online presence, to retrieve some or all of the information maintained within the expert's online presence. In various embodiments, this includes central profile information for the online presence, including, for example, the expert's name; the expert's affiliations and/or certifications or awards; images and/or video showing the expert or scenes associated with the expert; etc. Additionally, the facility accesses one or more posts or other items published by the expert, which may include, for example, titles; text; images and/or video; links; etc. In some embodiments, the facility extracts some or all of the individual frames of video sequences as standalone images. In some embodiments, the text and/or metadata of the visual artifacts includes text identifying one or more items, such as by brand and/or item name, model number, link to a webpage associated with the item, etc. The text and visual artifacts may similarly contain information about those items such as a description, discussion of merits, rating, example of use, references to other external reviews and ratings, etc. In some embodiments, the accessed information also includes information in a variety of other forms, including groups or bundles of items that the expert sees as related, calendars, associated experts, etc.

In various embodiments, the social media server hosts an online presence platform used by the expert, such as, for example, Instagram, YouTube, Twitter, Snapchat, Facebook, TikTok, WordPress, Wix, Weebly, or Medium. In some embodiments, the facility calls an API provided by the platform for programmatic access to the contents of the expert's online presence. In some embodiments, the facility uses credentials of the expert to impersonate the expert to the social media server, and scrapes the content presented in the expert's online presence. In some embodiments, the facility scrapes content from a publicly-available view of the expert's online presence, without using credentials of the expert.

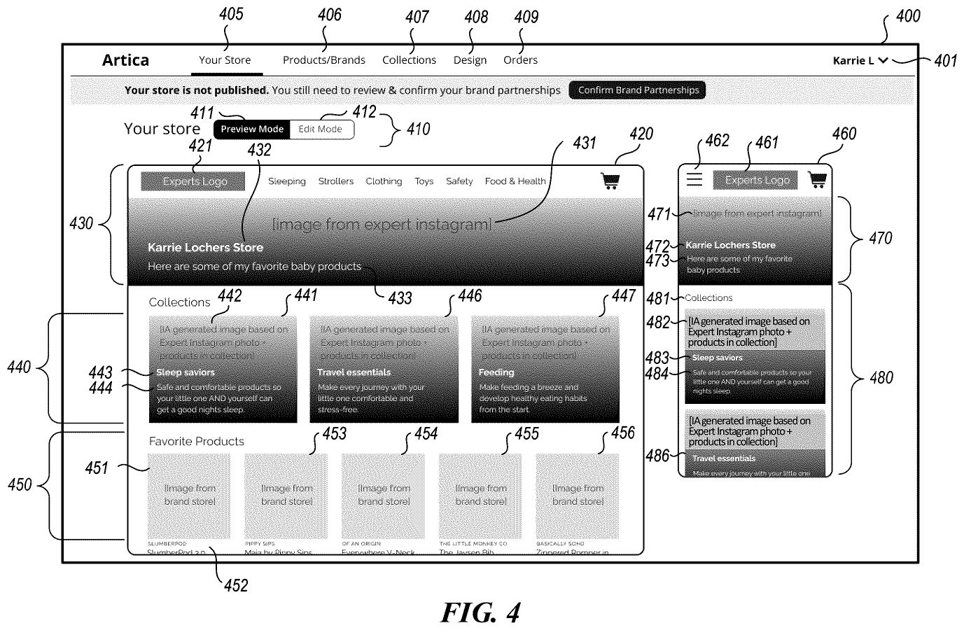

In act 302, the facility constructs an item transfer mechanism based upon the data accessed in act 301 from the online presence. In various embodiments, this involves using large language models, machine learning of other types, and/or other natural language processing tools to analyze various portions of the information accessed from the online presence. The item transfer mechanism constructed by the facility includes identifying information for the expert; items that are the same as or relevant to items published about by the expert available for transfer; and content published by the expert about such items, or automatically generated based upon content published by the expert. Various aspects of the constructed item transfer mechanism are shown in FIGS. 4, 5, and 9, and discussed below.

In act 303, the facility causes a preview of the item transfer mechanism constructed in act 302 to be displayed for review by the expert. This display of the preview includes the ability to traverse different pages and features of the item transfer mechanism in a manner that closely corresponds to the experience that an item transferee will have in using the live item transfer mechanism after launch. In some embodiments (not shown), the facility provides for the expert's review and revision of the item transfer mechanism in a mode other than preview mode, such as a mode that is more visually compact, a mode that better accommodates editing controls, etc.

FIG. 4 is a display diagram showing a preview view of a homepage of a sample item transfer mechanism constructed by the facility in some embodiments. The display 400 shows a starting point in the item transfer mechanism where transferees can enter the item transfer mechanism, orient themselves and navigate to different portions of the item transfer mechanism and items listed therein. An expert identifier indication 401 shows the account of the facility that the expert is using to construct the integrated item transfer mechanism. A navigation bar contains controls for jumping to different navigation destinations, such as a control 405 to jump to the item transfer mechanism, a control 406 for jumping to items and their sources, a control 407 for jumping to collections of items, a control 408 for jumping to a design area, and a control 409 for jumping to transfer orders placed for items by transferees. The display also includes a mode control 410 that the expert can manipulate in order to switch between the present preview mode 411 showing how the item transfer mechanism will appear to transferees, and the edit mode 412 that the expert can use in order to modify the item transfer mechanism.

The display further contains a desktop preview area 420 and a mobile preview 460. For the present page of the item transfer mechanism being previewed—the homepage—the desktop preview area shows how the page will look to a transferee visiting it using a browser displayed on a larger screen, such as that of a desktop or laptop computer, while the mobile preview area shows how the same page will appear to transferees viewing it through a browser on a device with a smaller screen, such as a smartphone, tablet, smartwatch, etc.

The desktop preview area 420 includes an expert identification region 430. As shown, the expert identification region includes a logo 421 used by the expert, such as one automatically identified in the expert's online presence. The region also includes controls that the transferee can use to jump to different destinations in the item transfer mechanism, such as those corresponding to different subjects and/or item categories. The region also includes an image 431 representing the expert, such as an image of the expert's face, an image of a larger portion of the expert's body, an illustration of the expert, an image of a place associated with the expert, etc. In various embodiments, the facility identifies references to items using regular expression matching, named-entity recognition-such as using a large language model, and/or projection of the content into a similarity comparison space to compare to representations of items projected into the same similarity comparison space. The region also includes a name 432 of the item transfer mechanism that identifies the expert, such as by including their name, here “Karrie Locher.” While FIG. 4 and display diagrams that follow have been simplified to omit images typically displayed by the facility—such as images 421 and 431—those skilled in the art will appreciate that versions of these displays presented to the expert and to item transferees will contain these images, as extracted from the online presence and/or automatically generated by generative Al tools.

The mobile preview area 460 contains a corresponding expert identification region 470. Inside is an expert image 471 corresponding to expert image 431 in the desktop preview—such as one that has been cropped or reformulated at a lower resolution. It further contains an item transfer mechanism name 472 corresponding to item transfer mechanism name 432, and narrative about the expert's area of expertise 473 corresponding to narrative 433, which in some embodiments is truncated or automatically summarized to save space.

The desktop view 420 further includes a collections region 440 that contains information about collections of related items, such as collections specified explicitly by the expert in their online presence, or collections automatically inferred by the facility from among the items published about in the online presence. The collections region includes information 441 about a first collection of items, information 446 about a second collection of items, and information 447 about a third collection of items. The information about each collection contains various information about the collection. For example, collection information 441 about the first collection includes an image 442 representing the collection, a name 443 for the collection, and a description 444 for the collection. The mobile view 460 includes a corresponding collections region 480 with information 481 about the first collection corresponding to information 441 in the desktop view, and information 486 about the second collection corresponding to information 446.

In some embodiments, the expert can scroll the mobile view and the desktop view to see content of those views that is out of sight in FIG. 4. For example, scrolling the mobile view will display presently undisplayed information about the third collection corresponding to information 447, as well as further content corresponding to items in the favorite products region 440 of the desktop view.

The desktop view further includes the items section 440 containing information about a number of items listed for transfer by the item transfer mechanism. For example, images 451, 453, 454, 455, and 456, each corresponding to a different listed item are shown, along with textual information naming and/or describing the item, such as textual information 452 for the item pictured in image 451. As noted, these items are also shown in the mobile view after scrolling down.

In some embodiments, the item transfer mechanism created by the facility includes additional sections not shown in FIG. 4, such as an about me section and a blog pages section. In some embodiments, the about me section includes content describing the expert, such as a photo of the expert, links to webpages associated with the expert such as social media profiles, and a textual biography of the expert. In some embodiments, the blog section enables the expert to publish long-form content to engage with their audience and improve the performance of their item transfer mechanism. In some embodiments, the facility automatically identifies an existing blog of the expert and integrates it into the blog section.

In some embodiments, the expert is an online influencer who publishes on a social media account about items that are products in a particular product category-whether physical products, entertainment products, virtual produces, services, or other purchasable and/or consumable items—and is compensated for selling published-about items by the manufacturer, brand, or other seller of these products in a web store described herein as an item transfer mechanism.

While FIG. 4 and each of the display diagrams discussed below show a display whose formatting, organization, informational density, etc., is best suited to certain types of display devices, those skilled in the art will appreciate that actual displays presented by the facility may differ from those shown, in that they may be optimized for particular other display devices, or have shown visual elements omitted, visual elements not shown included, visual elements reorganized, reformatted, revisualized, or shown at different levels of magnification, etc.

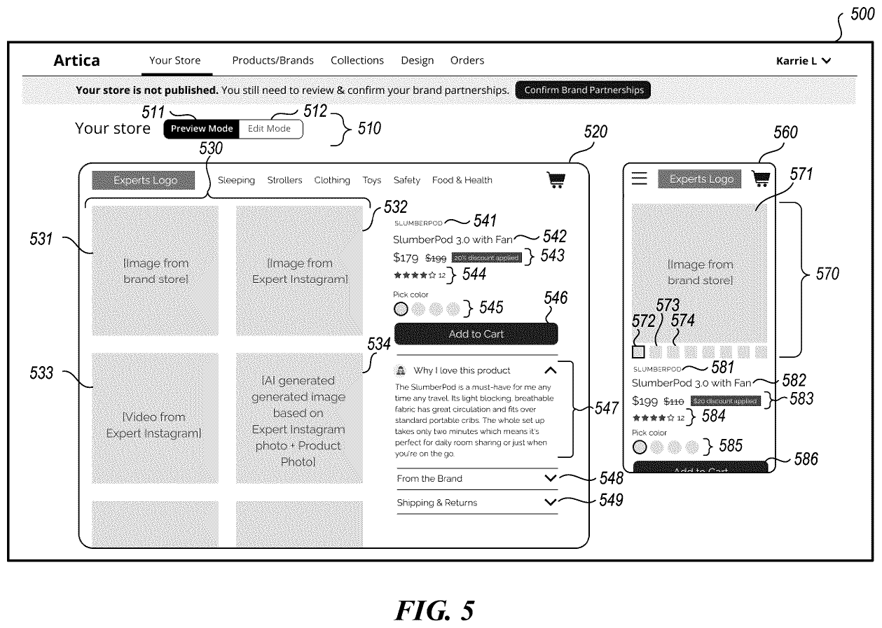

FIG. 5 is a display diagram showing a sample display presented by the facility in some embodiments to show details about an item listed for transfer on the item transfer mechanism constructed by the facility. The display 500 indicates that this item detail page is being displayed in preview mode 511. The desktop view is again branded with the expert's logo, and contains images relating to the item, such as images 531-534. In various embodiments, the images are obtained by the facility from the source 541 of the item, the expert's online presence, or a generative model for images or video, as examples. The desktop display further includes a name 542 of the item; a price 543 for the item that has been discounted in accordance with a discount rate extended by the item's source to customers of the expert; and a summary 544 of user ratings of the item. The desktop display further includes a control 545 for selecting one of the colors in which the item is available, and a control 546 that a transferee can activate in order to add the item to a shopping cart, from which the transferee can request transfer of the item. The desktop view further includes text 547 about why the expert like the item, either extracted from text appearing in the expert's online presence, transcribed from audio or the audio track of video appearing in the expert's online presence, or automatically generated in the expert's voice based upon statements made by the expert in their online presence. The desktop view further includes description 548 of the item provided by its source, and information 549 about the item transfer mechanism's policies for shipping and returning transferred items. The mobile view 560 shows corresponding information, including an image viewer 570 that can be used to cycle through images 531, 532, 533, 534 by clicking on thumbnails 572-574. The mobile view further includes corresponding item name 582, item price 583, customer review summary 584, color picker 585 and add to cart control 586.

Returning to FIG. 3, after the facility has displayed the preview, the expert can issue a command 304; where the command is to edit the item transfer mechanism, then the facility continues in act 305; where the command is to manage item source approvals, then the facility continues in act 306; and where the command is to launch the item transfer mechanism, then the facility continues in act 307. In act 305, in response to the edit command, the facility enables the expert to edit an aspect of the item transfer mechanism using an edit mode of the facility's user interface. After act 305, the facility continues in act 303 to display a preview of the item transfer mechanism that reflects the edit performed in act 305.

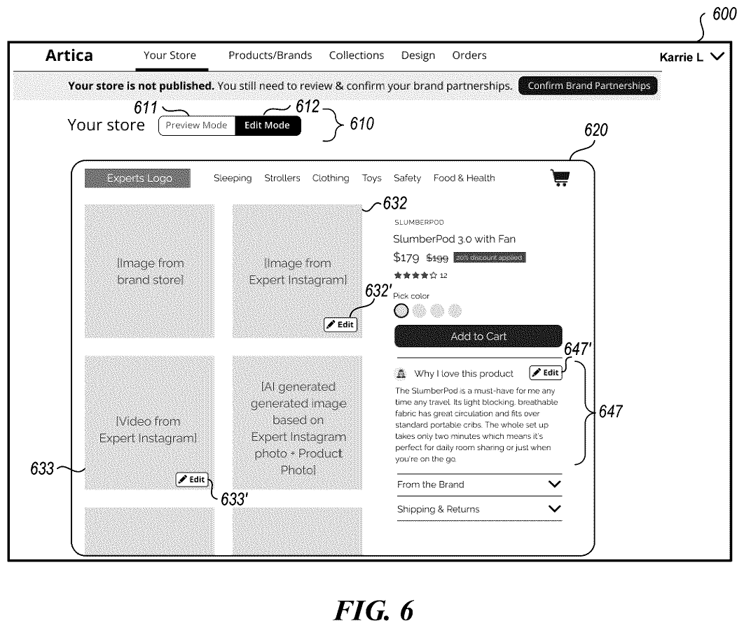

FIG. 6 is a display diagram showing a sample display presented by the facility in some embodiments to edit the item detail page shown in FIG. 5. In some embodiments, the facility presents this display 600 in response to the expert activating control 512 in FIG. 5 to change the mode from preview mode to edit mode. The display 600 shows that edit mode 612 is presently selected; the expert can activate preview mode control 611 to switch back to preview mode. The desktop view 620 includes an editing control 632′ to change the image 632; editing control 633′ to change the image 633; and editing control 647′ to change text 647. In response to activation of editing control 647′, in some embodiments, the facility displays a text editing window in which it displays text 647, and permits the expert to revise this text. In some embodiments, when the user selects editing control 632′ or 633′, the facility displays an image chooser window, in which the current image (e.g., image 632) is displayed as selected, and the expert can change the selection to another available image, such as an image extracted from the expert's online presence, an image supplied explicitly by the expert for this purpose, an image obtained from the item's source, or an image created by a generative Al tool. After making any such changes, the expert can activate preview mode control 611 to see how the changes appear in both the desktop view and the mobile view that is not presently shown.

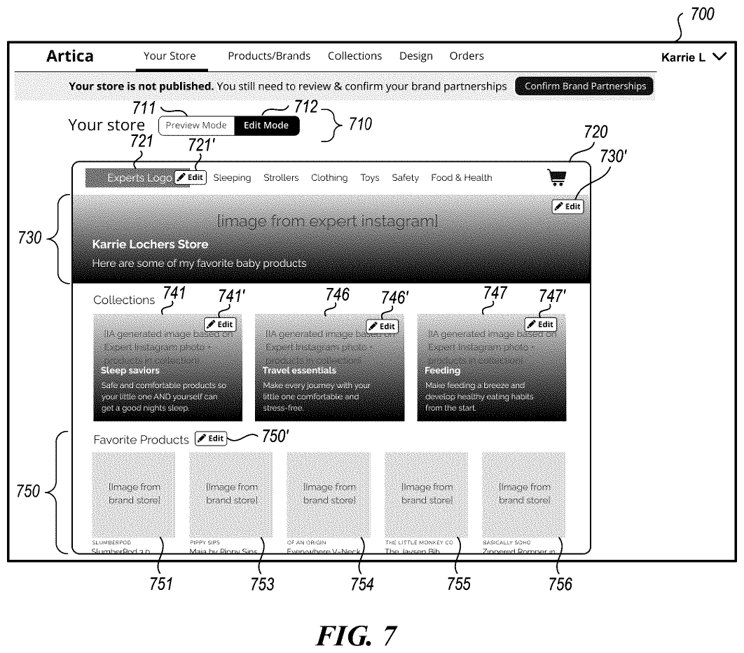

FIG. 7 is a display diagram showing sample contents of a display presented by the facility in some embodiments to enable the expert to edit the homepage display shown in FIG. 4. In some embodiments, the facility presents this display 700 in response to user activating edit mode control 412 shown in FIG. 4. It can be seen by the highlighting of edit mode control 712 shown in FIG. 7 that this display is in edit mode. It can further be seen that the facility has added a control 721′ for editing the expert's logo 721 and edit control 730′ to edit the expert identification region 730; edit controls 741′, 746′, and 747′ to respectively edit collections information 741, 746, and 747; and edit control 750′ to edit the set of listed items 750, including items 751, 753, 754, 755, and 756.

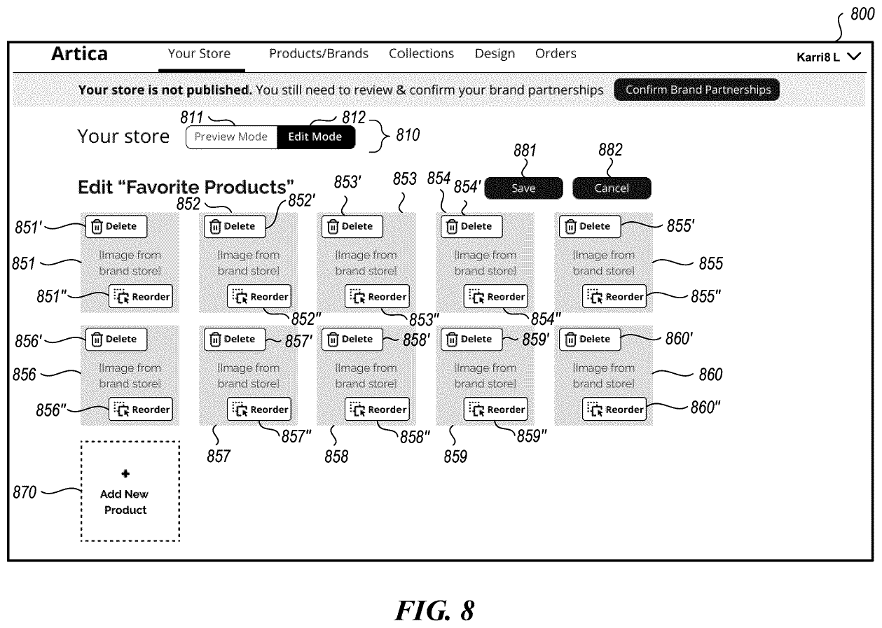

FIG. 8 is a display diagram showing sample contents of a display presented by the facility in some embodiments to edit the set of items listed for transfer on the item transfer mechanism. In some embodiments, the facility presents this display 800 in response to the expert activating editing control 750′ shown in FIG. 7. It can be seen by the highlighting of edit mode control 812 that edit mode is selected for this display. For each of listed items 851-860, the facility displays a delete control to delete the item from among the listed items, and a reorder control in order to move the item to a new position among the set of listed items. For example, for item 851, the facility displays a delete control 851′ and a reorder control 851″. The display also includes a control 870 for adding an item to the set of items. After the expert has made any desired adjustments to the set of listed items, the expert can activate save control 881 to save these changes. The expert can activate cancel control 882 in order to cancel any changes and revert to the prior set of items.

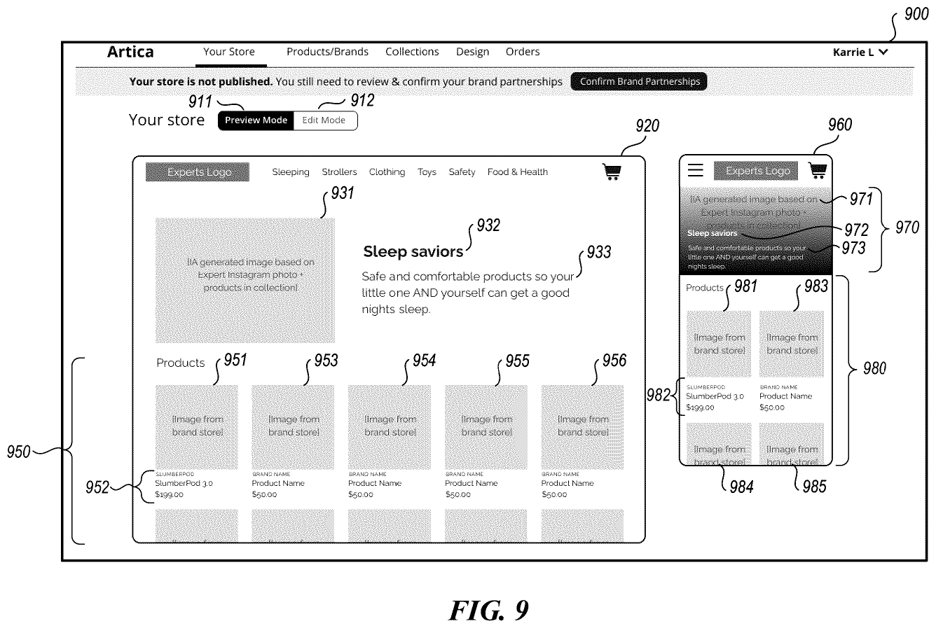

FIG. 9 is a display diagram showing sample contents of a display presented by the facility in some embodiments to show a page for a particular collection of items. In some embodiments, the facility presents display 900 in response to the expert's activation of edit control 741′ shown in FIG. 7. Because the preview mode control 911 is highlighted, it can be seen that this display is presented by the facility in preview mode. The desktop view 920 shows an image 931 for the item collection; a name 932 of the item collection; and a description 933 of the item collection. It further shows a group 950 of items in the item collection, such as items 951, 953, 954, 955, and 956, as well as textual information about each item, such as textual information 952 for the item shown in image 951. The mobile view 960 contains corresponding information, including item images 981, 983, 984, and 985 corresponding to item images 951, 953, 954, and 955 in the desktop view.

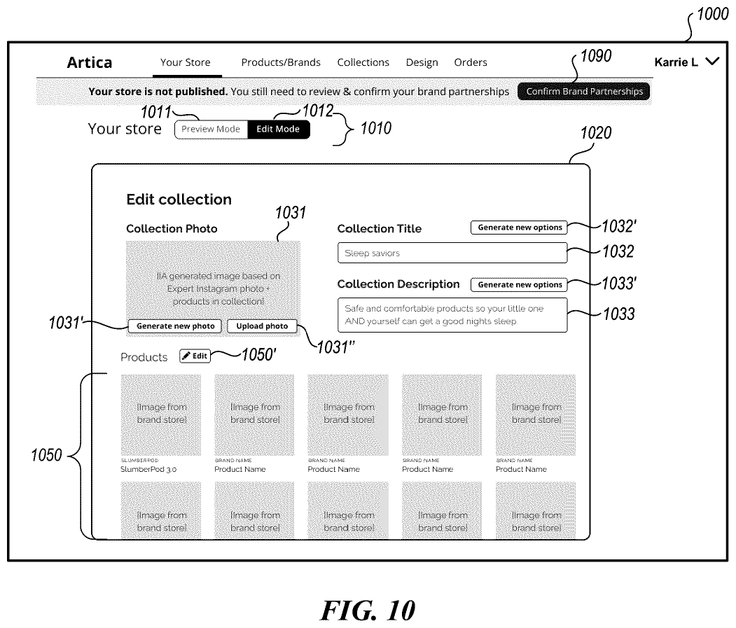

FIG. 10 is a display diagram showing sample contents of a display presented by the facility in some embodiments to edit an item collection. In some embodiments, the facility presents display 1000 in response to the expert activating edit mode control 912 shown in FIG. 9. Because the edit mode 1012 shown in FIG. 10 is highlighted, it can be seen that the facility presents display 1000 in edit more. The desktop view 1020 includes edit control 1031′ for generating a new version of image 1031 using a generative Al tool and a control 1031″ for uploading a replacement photo. The expert can activate control 1032′ to generate new options for the collection title 1032, such as using a generative Al tool. Similarly, the expert can activate control 1033′ in order to generate new options for the collection description text 1033. Also, the expert can activate edit control 1050′ to edit the set of items in the item collection. In some embodiments, when the expert does so, the facility presents a display similar to display 800 shown in FIG. 8. The display further includes a control 1090 that the expert can activate in order to manage approvals from item sources to list their items for transfer in the item transfer mechanism.

Returning to FIG. 3, in act 306, in response to receiving a manage approvals command from the expert-such as by activating control 1090 shown in FIG. 10, the facility manages listing approvals by the sources of the listed items. After act 306, the facility continues in act 303 to again display the preview of the item transfer mechanism.

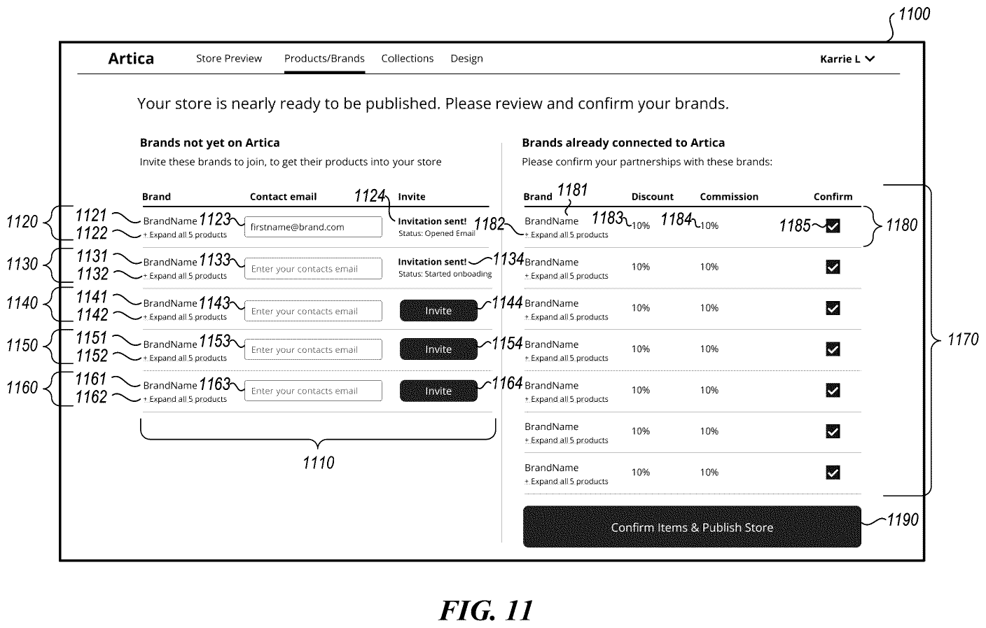

FIG. 11 is a display diagram showing sample contents of a display presented by the facility in some embodiments to manage item source approvals. In some embodiments, the facility presents the display 1100 in response to the expert's activation of control 1090 shown in FIG. 10. The display includes a list 1170 of item sources whose items are listed in the expert's item transfer mechanism who have granted their approval to list their items in the item transfer mechanism. For example, row 1180 shows, for item source 1181, that the expert can offer the source's items to transferees at a 10% discount and receive a 10% commission for these orders. The expert can activate control 1182 in order to show the items from source 1181, and can check box 1185 to confirm the discount and commission levels listed. In some cases, an item source may have given approval on an expert-by-expert basis, individually specifying discount level and commission level for each expert. In some cases, an item source gives approval for a larger group of experts, such as a list of experts or all interested experts. In such cases, the item source can choose to specify the same discount level and commission level for the entire group.

The display also shows a list 1110 of item sources whose items are listed in the item transfer mechanism who have not yet granted approval for the listing of their items there. Rows 1120 and 1130 contain indications that invitations have already been sent to these item sources requesting their approval. In particular, these rows contain status notifications 1124 and 1134 regarding the process of receiving and processing these approvals. Rows 1140, 1150, and 1160 correspond to item sources to which requests for approval have not yet been sent. To send such a request for item source 1141, the expert can enter an email address for this item source, then activate the invite control 1144 in order to send an invitation for receipt by the item source and processing to provide approval. In particular, in some embodiments, the email contains a link that the recipient can activate to interact with a user interface provided by the facility to give the item source's approval and specify a discount level and a commission level for the expert. When the list 1170 of item sources that have provided approval are adequate to operate the item transfer mechanism, the expert can activate control 1190 to launch the item transfer mechanism.

Returning to FIG. 3, in act 307, in response to receiving a launch command from the expert—such as by activating 1190 shown in FIG. 11—the facility launches the item transfer mechanism for use by transferees, making available for transfer all those listed items whose sources have provided approval. After act 307, the facility continues in act 303. In some embodiments, the process of launching the item transfer mechanism includes adding a direct or indirect link to the item transfer mechanism to the expert's online presence, embedding the item transfer mechanism in the expert's online presence, and/or sending to followers of the expert's account direct messages containing a link to the item transfer mechanism.

Those skilled in the art will appreciate that the acts shown in FIG. 3 may be altered in a variety of ways. For example, the order of the acts may be rearranged; some acts may be performed in parallel; shown acts may be omitted, or other acts may be included; a shown act may be divided into subacts, or multiple shown acts may be combined into a single act, etc.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. One or more instances of computer-readable media collective having contents configured to cause a computing system to perform a method, the method comprising:
using information provided by an expert to access an online presence of the expert;
extracting content from the online presence of the expert;
subjecting the extracted content to one or more natural language processing tools to:
identify items referred to by the extracted content;
for each identified item, identify content among the extracted content characterizing the identified item;
constructing an item transfer mechanism that makes each of the identified items available for transfer to transferees, the item transfer mechanism incorporating, for each of the identified items, content among the extracted content identified as characterizing the identified item;
operating the item transfer mechanism in a preview mode for the expert;
receiving input from the expert adjusting the item transfer mechanism to constitute a revised item transfer mechanism; and
operating the revised item transfer mechanism in a production mode for transferees.

2. The one or more instances of computer-readable media of claim 1 wherein the received input adjusts the item transfer mechanism by altering the plurality of items made available for transfer to transferees by the item transfer mechanism.

3. The one or more instances of computer-readable media of claim 1 wherein the received input adjusts the item transfer mechanism by altering text identified in the extracted content as characterizing one of the plurality of items.

4. The one or more instances of computer-readable media of claim 1 wherein the received input adjusts the item transfer mechanism by, for distinguished text identified in the extracted content as characterizing one of the plurality of items, selecting among revised textual passages proposed by a large language model to replace the distinguished text.

5. The one or more instances of computer-readable media of claim 1 wherein the received input adjusts the item transfer mechanism by changing a set of one or more images identified in the extracted content as characterizing one of the plurality of items.

6. The one or more instances of computer-readable media of claim 1, further comprising:
among the plurality of items, identifying a plurality of sources;
for each of at least a portion of the identified plurality of sources, seeking approval from to source to include items from the source in the constructed item transfer mechanism; and
in the item transfer mechanism operated in production mode for transferees, making available for transfer only items whose sources have provided approval.

7. The one or more instances of computer-readable media of claim 1, further comprising:
by the item transfer mechanism operated in production mode for transferees, receiving input from a distinguished transferee selecting one of the plurality of items; and
in response to receiving the input from the distinguished transferee, transferring an instance of the selected item to the distinguished transferee.

8. One or more computer memories collectively containing an item transfer mechanism data structure, the data structure comprising:
first information identifying a plurality of items identified by performing natural language processing against content published in an online presence of an expert;
second information representing, for each of the plurality of items, content published in the online presence of the expert that relates to the item, the second information comprising at least one text string and at least one still image, video sequence, audio/video sequence or audio sequence; and
third information specifying pricing for each of the plurality of items, such that the contents of the data structure are usable to operate an item transfer mechanism on behalf of the expert, in which any of the plurality of items identified by the first information can be transferred to a transferee in accordance with the pricing specified by the third information, the item transfer mechanism presenting the content represented by the second information in connection with each of the plurality of items identified by the first information.

9. The one or more computer memories of claim 8 wherein at least a portion of the second information represents content extracted from the online presence of the expert using a large language model.

10. The one or more computer memories of claim 8, the data structure further comprising:
fourth information representing, for each of at least a portion of the plurality of items, text generated by a generative ai tool using content extracted from the online presence of the expert, and wherein the contents of the data structure are further usable to present the content represented by the fourth information in connection with at the at least a portion of the plurality of items identified by the first information.

11. The one or more computer memories of claim 8, the data structure further comprising:
fourth information representing, for each of at least a portion of the plurality of items, visual content generated by a generative ai tool using content extracted from the online presence of the expert,
and wherein the contents of the data structure are further usable to present the content represented by the fourth information in connection with at the at least a portion of the plurality of items identified by the first information.

12. The one or more computer memories of claim 8 wherein the first information, or the second information, or the third information, or the first and second information, or the second and third information, or the first, second, and third information having been adjusted to reflect input from the expert.

13. The one or more computer memories of claim 8, the data structure further comprising:
fourth information specifying, for each of a plurality of sources for items among the plurality of items, whether the source has approved including items of the source in the item transfer mechanism operated on behalf of the expert using the contents of the data structure,
such that only items of sources that the fourth information specifies have approved including items of the source in the item transfer mechanism operated on behalf of the expert using the contents of the data structure are included in the item transfer mechanism operated on behalf of the expert using the contents of the data structure.

14. The one or more computer memories of claim 8, the data structure further comprising:
fourth information specifying, for each of at least a portion of a plurality of sources for items among the plurality of items, a commission level to be received by the expert with respect to items transferred to a transferee via the item transfer mechanism operated on behalf of the expert using the contents of the data structure.

15. A method in a computing system, the method comprising:
accessing an online presence of an expert;
extracting content from the online presence of the expert;
identifying items referred to by the extracted content;
for each identified item, identifying content among the extracted content characterizing the identified item;
constructing an item transfer mechanism that makes each of the identified items available for transfer to transferees, the item transfer mechanism incorporating, for each of the identified items, content among the extracted content identified as characterizing the identified item; and
operating the item transfer mechanism in a production mode for transferees.

16. The method of claim 15 wherein the expert's online presence is a social media account of the expert.

17. The method of claim 15 wherein the online presence is provided using an online presence platform,
and wherein the accessing comprises calling an API exposed by the online presence platform to retrieve the extracted content.

18. The method of claim 15 wherein the online presence is provided using an online presence platform,
and wherein the accessing comprises scraping the extracted from the online presence platform by impersonating a user of the online presence platform other than the expert.

19. The method of claim 15 wherein the online presence is provided using an online presence platform,
and wherein the accessing comprises scraping the extracted from the online presence platform by impersonating the expert using credentials of the expert for the online presence platform.

20. The method of claim 15 wherein identifying items, identifying content, or identifying items and content is performed using a large language model.

21. The method of claim 15, further comprising:
invoking a generative ai tool to create content characterizing the identified item based on content extracted from the online presence.

22. The method of claim 15, further comprising:
operating the item transfer mechanism in a preview mode for the expert; and
receiving input from the expert adjusting the item transfer mechanism to constitute the revised item transfer mechanism,
wherein it is the revised item transfer mechanism that is operated in production mode for transferees.

23. The method of claim 22 wherein the received input adjusts the item transfer mechanism by altering the plurality of items made available for transfer to transferees by the item transfer mechanism.

24. The method of claim 22 wherein the received input adjusts the item transfer mechanism by altering text identified in the extracted content as characterizing one of the plurality of items.

25. The method of claim 22 wherein the received input adjusts the item transfer mechanism by, for distinguished text identified in the extracted content as characterizing one of the plurality of items, selecting among revised textual passages proposed by a large language model to replace the distinguished text.

26. The method of claim 22 wherein the received input adjusts the item transfer mechanism by changing a set of one or more videos identified in the extracted content as characterizing one of the plurality of items.

27. The method of claim 22, further comprising:
among the plurality of items, identifying a plurality of sources;
for each of at least a portion of the identified plurality of sources, seeking approval from to source to include items from the source in the constructed item transfer mechanism; and
in the item transfer mechanism operated in production mode for transferees, making available for transfer only items whose sources have provided approval.

28. The method of claim 22, further comprising:
by the item transfer mechanism operated in production mode for transferees, receiving input from a distinguished transferee selecting one of the plurality of items; and
in response to receiving the input from the distinguished transferee, transferring an instance of the selected item to the distinguished transferee.
